(19) United States
(12) Patent Application Publication
(10) Pub. No.: US 2023/0025312 A1
(43) Pub. Date: Jan. 26, 2023

(54) LASER-ENABLED MULTI-LAYER INK ADHESION ONTO OPTICAL FIBERS

(71) Applicant: CORNING INCORPORATED, CORNING, NY (US)

(72) Inventors: Andres Covarrubias Jaramillo, Hampstead, NC (US); John Randolph Phillips, Wilmington, NC (US); Alranzo Boh Ruffin, Painted Post, NY (US); Sergio Tsuda, Horseheads, NY (US)

(21) Appl. No.: 17/867,147

(22) Filed: Jul. 18, 2022

Related U.S. Application Data
(60) Provisional application No. 63/224,938, filed on Jul. 23, 2021.

(30) Foreign Application Priority Data
Aug. 25, 2021 (NL) 2029055

(51) Int. Cl. G02B 6/44; G02B 6/036; G02B 6/42; H01S 3/067

(52) U.S. Cl. CPC G02B 6/4482; G02B 6/036; G02B 6/4296; H01S 3/06708

(57) ABSTRACT

A method of marking an optical fiber that includes directing a laser beam onto a first colored layer of an optical fiber. The optical fiber includes a core and a cladding surrounding the core, the first colored layer surrounds the cladding, and the laser beam modifies the first colored layer to form one or more laser-modified regions along an outer surface of the first colored layer.

This application claims the benefit of priority to Dutch Patent Application No. 2029055 filed on Aug. 25, 2021, which claims priority from U.S. Provisional Patent Application Ser. No. 63/224,938 filed on Jul. 23, 2021, the content of which is relied upon and incorporated herein by reference in its entirety.

### BACKGROUND

### Field

The present specification generally related to apparatuses and methods for laser-enabled adhesion of ink over an existing color layer of optical fibers to increase the number of color-coded identifications of individual optical fibers in groups of optical fibers, such as in a cable assembly or devices with multiple fiber inputs and outputs.

### Technical Background

Optical communications rely on cable assemblies that include multiple optical fibers to maximize data transmission rates. Construction of optical fiber networks frequently requires splicing and joining of individual optical fibers in different cable assemblies. When joining optical fibers after splicing, it is necessary to map optical fiber connections in different cable assemblies to enable tracking of the optical signal. Mapping of optical fiber connections is accomplished by applying distinct indicia, such as identifying marks, to the individual optical fibers and matching the indicia when joining optical fibers from different cable assemblies.

Conventionally, optical fibers in a cable assembly are limited to 12 colors for use as identifying marks. The limited number of colors creates design hurdles for increasing data throughput by increasing the number of fibers in a cable assembly. Current attempts to increase the number of identifying marks focus on combinations of two or more of the 12 colors. In a typical process, the optical fiber includes a color layer that extends along the length of the fiber and one or more additional marks are applied underneath the color layer at selected locations along the optical fiber (typically near the ends to simplify joining). If the color layer is sufficiently translucent (e.g. by controlling its thickness), the underlying additional marks are visible and the combination of underlying marks and color layer functions to identify the fiber and the number of unique identifying indicia is increased. These methods, however, are costly and result in attribute degradation (e.g. delamination of the color layer).

Optical fiber and optical cable lengths are typically on the 10's to 100's of kilometers and both the optical waveguiding properties and the integrity of optical fibers and optical cables are dependent on the integrity of each component. Thus, the color marking process for optical fiber identification must be robust and indelible. One current color marking process includes applying a coded black tracer on top of a secondary coating and overcoating with a semi-transparent color ink layer through which the coded black tracer is visible. However, this process has drawbacks. Some colors for the color ink layer do not have the transparency required for visibility of the black ink tracers. Some colors for the color ink layer change the perceived color of the secondary colored layer. Moreover, current solutions cause large performance penalties for optical signal transmission through the optical fiber.

Accordingly, a need exists for methods and systems to increase the number of color identifiers that can be applied to an optical fiber without compromising optical performance.

### SUMMARY

According to a first aspect of the present disclosure, a method of marking an optical fiber includes directing a laser beam onto a first colored layer of an optical fiber, wherein: the optical fiber includes a core and a cladding surrounding the core, the first colored layer surrounds the cladding, and the laser beam modifies the first colored layer to form one or more laser-modified regions along an outer surface of the first colored layer.

A second aspect of the present disclosure includes the method of the first aspect, wherein the one or more laser-modified regions of the outer surface include a plurality of microcracks extending into the first colored layer, a plurality of protrusions extending from the first colored layer, or combinations thereof.

A third aspect of the present disclosure includes the method of the first aspect or the second aspect, wherein the one or more laser-modified regions comprise a thickness of from 0.2 μm to 3 μm.

A fourth aspect of the present disclosure includes the method of any of the previous aspects, wherein the one or more laser-modified regions comprise a thickness less than a thickness of the first colored layer.

A fifth aspect of the present disclosure includes the method of any of the previous aspects, wherein the one or more laser-modified regions comprise a plurality of laser-modified regions intermittently spaced along a length of the optical fiber.

A sixth aspect of the present disclosure includes the method of any of the previous aspects, wherein the one or more laser-modified regions comprise a single continuous laser-modified region extending along a length of the optical fiber.

A seventh aspect of the present disclosure includes the method of any of the previous aspects, further comprising translating the optical fiber along a fiber pathway while directing the laser beam onto the first colored layer of the optical fiber.

An eighth aspect of the present disclosure includes the method of the seventh aspect, wherein the fiber pathway is disposed along an optical fiber draw tower.

A ninth aspect of the present disclosure includes the method of the eighth aspect, wherein the optical fiber draw tower comprises a draw furnace, a fiber coating unit, a drying unit, a curing unit, an optical system for producing the laser beam, and a fiber collection unit, wherein the fiber pathway extends from the draw furnace to the fiber collection unit.

A tenth aspect of the present disclosure includes the method of the seventh aspect, wherein the fiber pathway is disposed along a spool-to-spool system.

An eleventh aspect of the present disclosure includes the method of the tenth aspect, wherein the spool-to-spool system comprises a first fiber spool, an optical system for producing the laser beam, and a second fiber spool, wherein the fiber pathway extends from the first fiber spool to the second fiber spool.

A twelfth aspect of the present disclosure includes the method of any of the previous aspects, wherein the laser beam is output by a beam source of an optical system and directed to the first colored layer along a laser pathway, the optical system comprising a first cylindrical lens and a second cylindrical lens positioned along the laser pathway between the beam source and the first colored layer, and the first cylindrical lens is rotated 90° about the laser pathway with respect to the second cylindrical lens.

A thirteenth aspect of the present disclosure includes the method of the twelfth aspect, wherein the laser beam is directed onto a first portion of a circumference of the first colored layer, the first portion extending around less than an entirety of the circumference, the one or more laser-modified regions formed on the first portion.

A fourteenth aspect of the present disclosure includes the method of the thirteenth aspect, further including directing a second laser beam onto a second portion of the circumference of the first colored layer, the second laser beam output by a second beam source of a second optical system and directed to the second portion along a second laser pathway, the second portion extending around less than the entirety of the circumference, the second laser beam forming one or more additional laser-modified regions on the second portion.

A fifteenth aspect of the present disclosure includes the method of the fourteenth aspect, wherein the first portion and the second portion combine to include the entirety of the circumference of the first colored layer.

A sixteenth aspect of the present disclosure includes the method of the fourteenth aspect, wherein the second optical system includes a third cylindrical lens and a fourth cylindrical lens positioned along the second laser pathway between the second beam source and the first colored layer and the third cylindrical lens is rotated 90° about the second laser pathway with respect to the fourth cylindrical lens.

A seventeenth aspect of the present disclosure includes the method of any of the previous aspects, wherein the laser beam is output by a beam source of an optical system along a laser pathway, the optical system comprising an aspheric optical element positioned along a first segment of the laser pathway between the beam source and a mirror, wherein the mirror optically couples the first segment of the laser pathway with a second segment of the laser pathway, the first segment of the laser pathway is orthogonal with the second segment of the laser pathway, the second segment of the laser pathway is collinear with a fiber pathway along which the optical fiber is positioned, and the fiber pathway extends through a hole in the mirror.

An eighteenth aspect of the present disclosure includes the method of the seventeenth aspect, further including a first lens positioned along the first segment of the laser pathway between the aspheric optical element and the mirror and a second lens positioned along the second segment of the laser pathway downstream the mirror, wherein the fiber pathway extends through a hole in the second lens.

A nineteenth aspect of the present disclosure includes the method of any of the previous aspects, wherein the laser beam is output by a beam source of an optical system, the optical system including an off-axis parabolic mirror optically coupled to the beam source and optically coupling a first segment of a laser pathway with a second segment of the laser pathway, wherein the first segment of the laser pathway is orthogonal with the second segment of the laser pathway, the second segment of the laser pathway is collinear with a fiber pathway along which the optical fiber is positioned, and the fiber pathway extends through a hole in the off-axis parabolic mirror.

A twentieth aspect of the present disclosure includes the method of any of the previous aspects, wherein the laser beam is output by a beam source of an optical system along a laser pathway, the optical system including a first aspheric optical element and a second aspheric optical element positioned along a first segment of the laser pathway between the beam source and a mirror, wherein the mirror optically couples the first segment of the laser pathway with a second segment of the laser pathway, a focusing mirror is positioned along the second segment of the laser pathway downstream the mirror, the first segment of the laser pathway is orthogonal with the second segment of the laser pathway, the second segment of the laser pathway is collinear with a fiber pathway along which the optical fiber is positioned, and the fiber pathway extends through a hole in the mirror and a hole in the focusing mirror.

A twenty-first aspect of the present disclosure includes the method of any of the previous aspects, further including applying an ink to the one or more laser-modified regions of the outer surface of the first colored layer to form a second colored layer directly adhered to the one or more laser-modified regions of the first colored layer.

A twenty-second aspect of the present disclosure includes the method of the twenty-first aspect, wherein the ink is applied by a rotogravure ink station.

A twenty-third aspect of the present disclosure includes the method of the twenty-first aspect, wherein the ink is applied by a jetting ink station.

A twenty-fourth aspect of the present disclosure includes the method of any of the twenty-first aspect through the twenty-third aspect, wherein the ink is a silicone based ink.

A twenty-fifth aspect of the present disclosure includes the method of any of the twenty-first aspect through the twenty-fourth aspect, wherein the first colored layer is a different color than the second colored layer.

A twenty-sixth aspect of the present disclosure includes the method of any of the previous aspects, wherein the laser beam comprises a pulsed laser beam.

A twenty-seventh aspect of the present disclosure includes the method of any of the previous aspects, wherein the laser beam comprises a continuous wave laser beam.

A twenty-eighth aspect of the present disclosure includes the method of any of the previous aspects, wherein the one or more laser-modified regions extend around at least 50% of a circumference of the outer surface of the first colored layer.

A twenty-ninth aspect of the present disclosure includes the method of any of the previous aspects, wherein the one or more laser-modified regions extend around at least 75% of a circumference of the outer surface of the first colored layer.

A thirtieth aspect of the present disclosure includes the method of any of the previous aspects, wherein the one or more laser-modified regions extend around at least 90% of a circumference of the outer surface of the first colored layer.

A thirty-first aspect of the present disclosure includes the method of any of the previous aspects, wherein the outer surface of the first colored layer comprises a portion not modified by the laser beam adjacent to the one or more laser-modified regions, the portion and the one or more laser-modified regions differing in a reflection or a scattering of visible light to provide an optical contrast of the portion relative to the one or more laser-modified regions.

A thirty-second aspect of the present disclosure includes the method of any of the previous aspects, wherein the outer surface of the first colored layer comprises a portion not modified by the laser beam adjacent to the one or more laser-modified regions, the one or more laser-modified regions having a higher root-mean-square roughness than the portion.

A thirty-third aspect of the present disclosure includes the method of any of the previous aspects, wherein the optical fiber comprises a buffer layer between the first colored layer and the cladding, the first colored layer surrounding the buffer layer and the buffer layer surrounding the cladding and wherein the buffer layer is not modified by the laser beam.

A thirty-fourth aspect of the present disclosure includes the method of the thirty-third, wherein the buffer layer is not ablated by the laser beam.

A thirty-fifth aspect of the present disclosure includes the method of any of the previous aspects, wherein the laser beam modifies the first colored layer by ablating the first colored layer.

According to thirty-sixth aspect of the present disclosure a method of marking a fiber bundle support includes directing a laser beam onto a first colored layer of a fiber bundle support, wherein the fiber bundle support is configured to house a plurality of optical fibers within an opening of the fiber bundle support and the laser beam modifies the first colored layer to form one or more laser-modified regions along an outer surface of the first colored layer.

A thirty-seventh aspect of the present disclosure includes the method of the thirty-sixth aspect, wherein the fiber bundle support comprises a cable jacket, the cable jacket comprising the first colored layer.

A thirty-eighth aspect of the present disclosure includes the method of the thirty-seventh aspect, wherein the cable jacket comprises an inner cable jacket configured to house a bundle of optical fibers, the first colored layer surrounding the inner cable jacket.

A thirty-ninth aspect of the present disclosure includes the method of the thirty-seventh aspect, wherein the cable jacket comprises an outer cable jacket configured to house a plurality of inner cable jackets each of the inner cable jackets configured to house a bundle of optical fibers, the outer cable jacket comprising the first colored layer.

A fortieth aspect of the present disclosure includes the method of the thirty-sixth aspect, wherein the fiber bundle support comprises a ribbon jacket.

A forty-first aspect of the present disclosure includes the method of any of the thirty-sixth through fortieth aspects, wherein the one or more laser-modified regions of the outer surface comprise a plurality of microcracks extending into the first colored layer, a plurality of protrusions extending from the first colored layer, or combinations thereof.

A forty-second aspect of the present disclosure includes the method of any of the thirty-sixth through forty-first aspects, wherein the one or more laser-modified regions comprise a thickness of from 0.2 μm to 3 μm.

A forty-third aspect of the present disclosure includes the method of any of the thirty-sixth through forty-second aspects, further including translating the fiber bundle support along a fiber bundle support pathway while directing the laser beam onto the first colored layer of the fiber bundle support.

A forty-fourth aspect of the present disclosure includes the method of the forty-third aspect, wherein the fiber bundle support pathway is disposed along a spool-to-spool system, wherein the spool-to-spool system comprises a first fiber spool, an optical system for producing the laser beam, and a second fiber spool, wherein the fiber bundle support pathway extends from the first fiber spool to the second fiber spool.

A forty-fifth aspect of the present disclosure includes the method of any of the thirty-sixth through forty-fourth aspects, wherein the laser beam is output by a beam source of an optical system and directed to the first colored layer along a laser pathway, the optical system comprising a first cylindrical lens and a second cylindrical lens positioned along the laser pathway between the beam source and the first colored layer and the first cylindrical lens is rotated 90° about the laser pathway with respect to the second cylindrical lens.

A forty-sixth aspect of the present disclosure includes the method of any of the thirty-sixth through forty-fifth aspects, wherein the laser beam is output by a beam source of an optical system along a laser pathway, the optical system comprising an aspheric optical element positioned along a first segment of the laser pathway between the beam source and a mirror, wherein the mirror optically couples the first segment of the laser pathway with a second segment of the laser pathway, the first segment of the laser pathway is orthogonal with the second segment of the laser pathway, the second segment of the laser pathway is collinear with a fiber bundle support pathway along which the fiber bundle support is positioned, and the fiber bundle support pathway extends through a hole in the mirror.

A forty-seventh aspect of the present disclosure includes the method of the forty-sixth aspect, further including a first lens positioned along the first segment of the laser pathway between the aspheric optical element and the mirror and a second lens positioned along the second segment of the laser pathway downstream the mirror, wherein the fiber bundle support pathway extends through a hole in the second lens.

A forty-eighth aspect of the present disclosure includes the method of any of the thirty-sixth through forty-seventh aspects, wherein the laser beam is output by a beam source of an optical system along a laser pathway, the optical system comprising an off-axis parabolic mirror optically coupled to the beam source and optically coupling a first segment of the laser pathway with a second segment of the laser pathway, wherein the first segment of the laser pathway is orthogonal with the second segment of the laser pathway, the second segment of the laser pathway is collinear with a fiber bundle support pathway along which the fiber bundle support is positioned, and the fiber bundle support pathway extends through a hole in the off-axis parabolic mirror.

A forty-ninth aspect of the present disclosure includes the method of any of the thirty-sixth through forty-eighth aspects, further including applying an ink to the one or more laser-modified regions of the outer surface of the first colored layer to form a second colored layer directly adhered to the one or more laser-modified regions of the first colored layer.

A fiftieth aspect of the present disclosure includes the method of any of the thirty-sixth through forty-ninth aspects, wherein the laser beam is output by a beam source of an optical system along a laser pathway, the optical system includes a first aspheric optical element and a second aspheric optical element positioned along a first segment of the laser pathway between the beam source and a mirror, wherein the mirror optically couples the first segment of the laser pathway with a second segment of the laser pathway, a focusing mirror is positioned along the second segment of the laser pathway downstream the mirror, the first segment of the laser pathway is orthogonal with the second segment of the laser pathway, the second segment of the laser pathway is collinear with a fiber bundle support pathway along which the fiber bundle support is positioned; and the fiber bundle support pathway extends through a hole in the mirror and a hole in the focusing mirror.

According to a fifty-first aspect of the present disclosure an optical fiber includes a core, a cladding surrounding the core, and a first colored layer surrounding the cladding, wherein the first colored layer comprises an outer surface, the outer surface corresponding to an outermost surface of the optical fiber, the outer surface comprising a first portion with a first root-mean-square roughness and a second portion with a second root-mean-square roughness less than the first root-mean-square roughness.

A fifty-second aspect of the present disclosure includes the method of the fifty-first aspect, further including one or more buffer layers surrounding the cladding and disposed between the cladding and the first colored layer.

A fifty-third aspect of the present disclosure includes the method of the fifty-first aspect or the fifty-second aspect, wherein the first portion of the outer surface include a plurality of microcracks extending into the first colored layer, a plurality of protrusions extending from the first colored layer, or a combination thereof.

A fifty-fourth aspect of the present disclosure includes the method of any of the fifty-first through fifty-third aspects, wherein the first portion comprises a thickness of from 0.2 μm to 3 μm.

A fifty-fifth aspect of the present disclosure includes the method of any of the fifty-first through fifty-fourth aspects, further including a second colored layer disposed on and in direct contact with the first portion.

A fifty-sixth aspect of the present disclosure includes the method of the fifty-fifth aspect, wherein the first colored layer is a different color than the second colored layer.

A fifty-seventh aspect of the present disclosure includes the method of the fifty-fifth aspect, wherein the first colored layer and the second colored layer each comprise a silicone based ink material.

A fifty-eighth aspect of the present disclosure includes the method of any of the fifty-first through fifty-seventh aspects, wherein the first portion of the outer surface and the second portion of the outer surface differ in optical reflectivity or scattering of visible light.

A fifty-ninth aspect of the present disclosure includes the method of any of the fifty-first through fifty-eighth aspects, wherein the first root-mean-square roughness is in a range of from 50 nm to 500 nm.

A sixtieth aspect of the present disclosure includes the method of the fifty-ninth aspect, wherein the second root-mean-square roughness is in a range of from 20 nm to 40 nm.

A sixty-first aspect of the present disclosure includes the method of any of the fifty-first through sixtieth aspects, wherein the first portion is a laser-modified region of the outer surface.

Additional features and advantages of the processes and systems described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a schematic illustration of an optical fiber draw tower that includes an optical system and an ink station, according to one or more embodiments described herein;

FIG. 2 is a schematic illustration of a spool-to-spool system that includes an optical system and an ink station, according to one or more embodiments described herein;

FIG. 3A is a schematic lengthwise cross section of an optical fiber undergoing laser processing to form one or more laser-modified regions in a first colored layer, according to one or more embodiments described herein;

FIG. 3B is a schematic radial cross section of the optical fiber of FIG. 3A undergoing laser processing to form one or more laser-modified regions in a first colored layer, according to one or more embodiments described herein;

FIG. 3C is a schematic illustration of a portion of the optical fiber of FIGS. 3A and 3B comprising a laser-modified region in the first colored layer that exhibits microcracks extending into the first colored layer, according to one or more embodiments described herein;

FIG. 3D is a schematic illustration of a portion of the optical fiber of FIGS. 3A and 3B comprising a laser-modified region in the first colored layer that exhibits protrusions extending from the first colored layer, according to one or more embodiments described herein;

FIG. 4 is a schematic cross section of an optical fiber having a first colored layer and a second colored layer directly adhered to one or more laser-modified regions of an outer surface of the first colored layer, according to one or more embodiments described herein;

FIG. 5A is a schematic side view of an optical system comprising a pair of cylindrical lenses, according to one or more embodiments described herein;

FIG. 5B is a schematic top view of the optical system of FIG. 5A, according to one or more embodiments described herein;

FIG. 5C is a grayscale cross section of a beam spot formed using the optical system of FIGS. 5A and 5B, according to one or more embodiments described herein;

FIG. 6 is a schematic illustration of an optical system comprising an aspheric optical element, according to one or more embodiments described herein;

FIG. 7A is a schematic illustration of an optical system comprising an off-axis parabolic mirror, according to one or more embodiments described herein;

FIG. 7B schematically depicts a Gaussian type laser beam formed using the optical system of FIG. 7A interacting with an optical fiber, according to one or more embodiments described herein;

FIG. 7C schematically depicts a Bessel type laser beam formed using the optical system of FIG. 7A interacting with an optical fiber, according to one or more embodiments described herein;

FIG. 8 is a schematic illustration of an optical system comprising two aspheric optical elements and a focusing mirror, according to one or more embodiments described herein;

FIG. 9A is a schematic illustration of a jetting ink station, according to one or more embodiments described herein;

FIG. 9B is a schematic illustration of a flexographic ink station, according to one or more embodiments described herein;

FIG. 9C is a detailed schematic view of the anilox roll of the flexographic ink station of FIG. 9B contacting a plate cylinder, according to one or more embodiments described herein;

FIG. 10 is a schematic illustration of another spool-to-spool system that includes an optical system and an ink station, according to one or more embodiments described herein;

FIG. 11A is a schematic illustration of fiber bundle support housing a plurality of optical fibers, according to one or more embodiments described herein;

FIG. 11B is a schematic cross section of fiber bundle support having a first colored layer and a second colored layer directly adhered to one or more laser-modified regions of an outer surface of the first colored layer, according to one or more embodiments described herein;

FIG. 12A depicts a glass sample having a first ink layer that is laser modified in a first region and is not laser modified in a second region, according to one or more embodiments described herein;

FIG. 12B depicts a partial view of the glass sample of FIG. 12A showing the first region and the second region of the first ink layer, according to one or more embodiments described herein;

FIG. 13A depicts a glass sample having a first ink layer comprising laser-modified regions and an unmodified region and a second ink layer disposed on the laser-modified regions of the first ink layer, according to one or more embodiments described herein;

FIG. 13B depicts the glass sample of FIG. 13A after wiping the second ink layer, according to one or more embodiments described herein;

FIG. 14A depicts a plurality of optical fibers having a first ink layer that has not been laser modified, according to one or more embodiments described herein; and

FIG. 14B depicts the plurality of optical fibers of FIG. 14A after laser modification of that the first ink layer, according to one or more embodiments described herein.

### DETAILED DESCRIPTION

Reference will now be made in detail to embodiments of methods and systems for processing optical fibers and fiber bundle supports, such as cable jackets, examples of which are illustrated in the accompanying drawings. Whenever possible, the same reference numerals will be used throughout the drawings to refer to the same or like parts. More specifically, the methods and systems described herein relate to laser-based systems and processes that enable the application and adhesion of a second colored layer directly over a first colored layer of an optical fiber or an optical fiber support to enable an increase in the number of color-coded identifications of individual optical fibers in a group of optical fibers, such as in bundles of optical fibers in a cable assembly. The embodiments described herein may be used to directly apply distinctive color markings (i.e., the second colored layer) onto an existing colored ink layer (i.e., the first colored layer) to uniquely identify and to make optical fibers and fiber bundle supports distinguishable to an in-field installation technician/engineer.

For example, in methods described herein, a laser beam may be directed onto the first colored layer of the optical fiber or the fiber bundle support to modify the first colored layer and form one or more laser-modified regions. The laser-modified regions may comprise microcracks, protrusions, or both, which enables ink or other coloring agent to be directly adhered to the first colored layer to form the second colored layer. The laser-modified regions are preferably shallow, having a thickness of about 10 μm or less in some embodiments. Thus, when formed in the first colored layer of an optical fiber, the laser-modified regions do not degrade the mechanical integrity of the optical fiber or the waveguiding properties and performance of the optical fiber. Moreover, the processes described herein provide a low-cost solution with good tolerance to positional accuracy of optical fibers and/or fiber bundle supports during the process. Various embodiments of methods and systems for processing optical fibers and fiber bundle supports to increase the number of color-coded identifications of individual optical fibers and bundles of optical fibers in a cable assembly will be described herein with specific reference to the appended drawings.

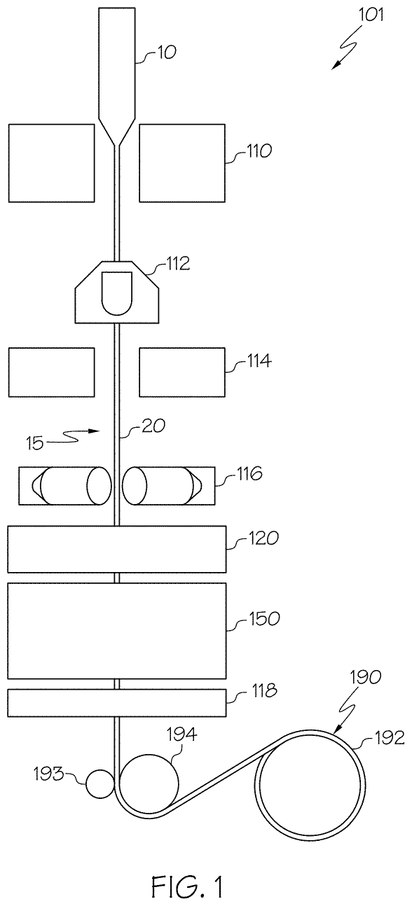

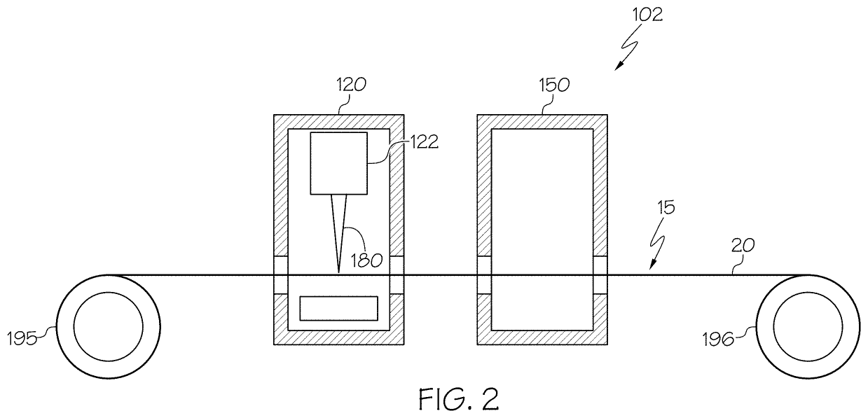

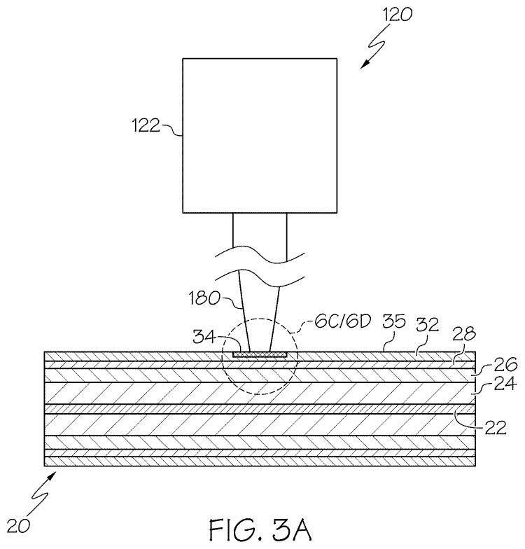

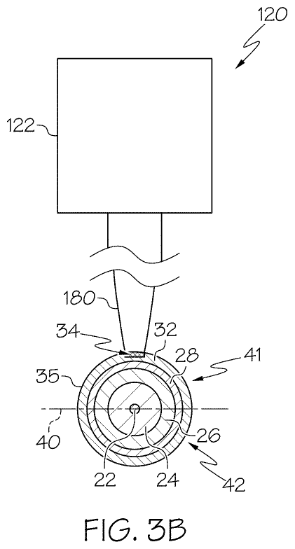

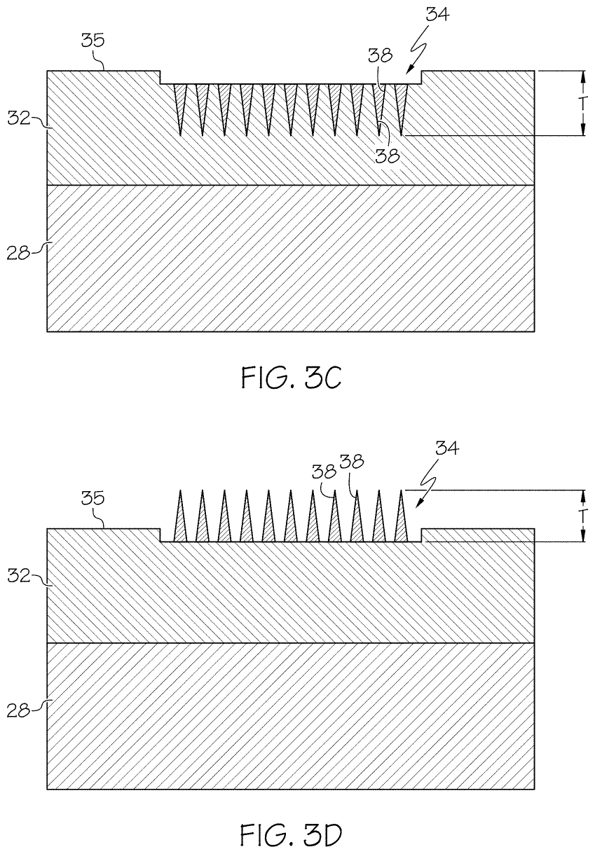

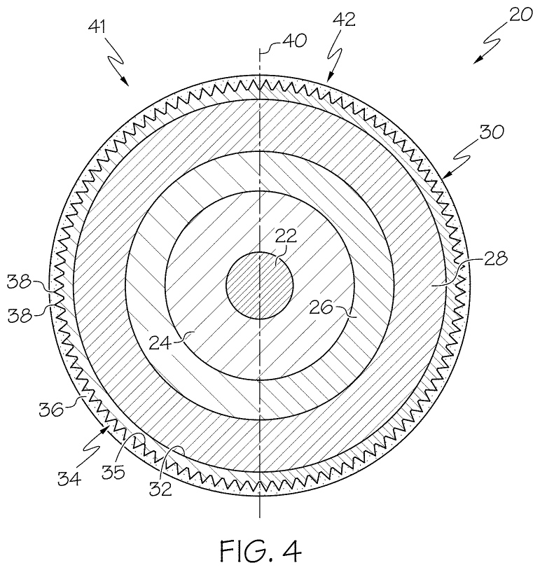

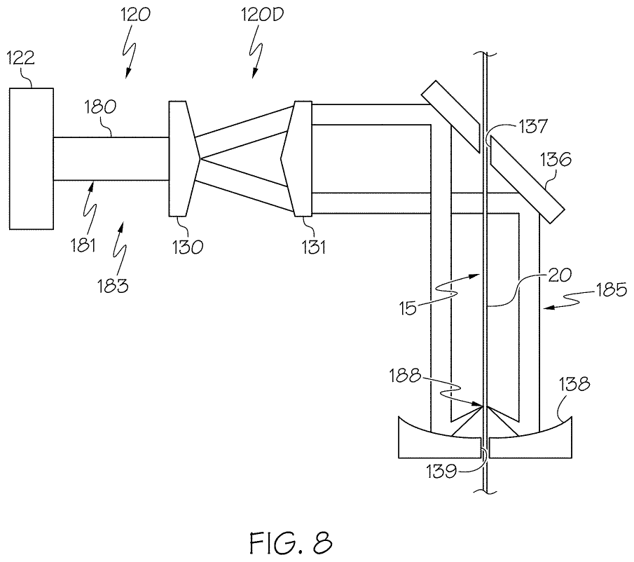

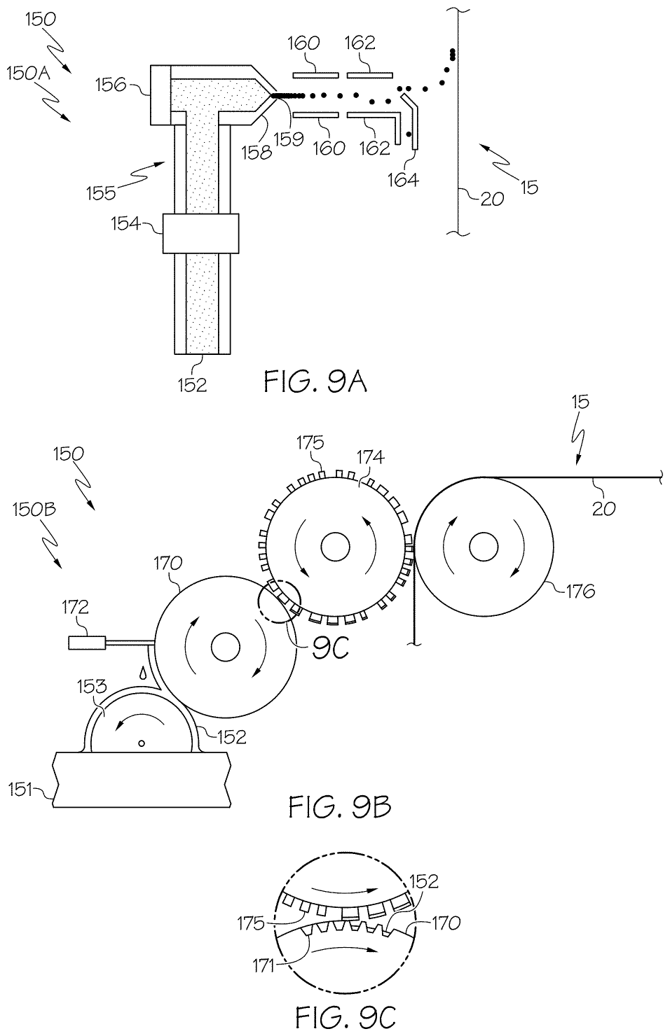

Referring now to FIGS. 1 and 2, processing systems configured to process an optical fiber 20 are schematically depicted. FIG. 1 depicts a processing system comprising an optical fiber draw tower 101 configured to draw the optical fiber 20 from an optical fiber preform 10. FIG. 2 depicts a processing system comprising a spool-to-spool system 102 configured to modify the optical fiber 20 in an offline process after the optical fiber 20 has been drawn. Both the optical fiber draw tower 101 and the spool-to-spool system 102 comprise an optical system 120 and an ink station 150. As described in detail herein, the optical system 120 is configured to modify, for example to ablate, a first colored layer 32 (FIGS. 3A-4) of the optical fiber 20 to form one or more laser-modified regions 34 on an outer surface 35 of the first colored layer 32 and the ink station 150 is configured to apply an ink 152 (FIGS. 9A-9C) to the one more laser-modified regions 34 to form the second colored layer 36 (FIG. 4) directly adhered to the one or more laser-modified regions 34 of the first colored layer 32.

Referring now to FIG. 1, the optical fiber draw tower 101 comprises a draw furnace 110, a coating station 112, a drying station 114, a first curing station 116, a second curing station 118 and a fiber collection unit 190. The optical fiber draw tower 101 further comprises the optical system 120 and the ink station 150. As depicted in FIG. 1, a fiber pathway 15 extends from the draw furnace 110 to the fiber collection unit 190 and is the pathway along which an optical fiber 20 travels during production. As depicted in FIG. 1, an optical fiber preform 10 is placed in the draw furnace 110. The optical fiber preform 10 may be constructed of any glass or material suitable for the manufacture of optical fibers 20 (e.g. silica, doped silica, or combinations thereof). In operation, the draw furnace 110 may heat the optical fiber preform 10 such that the optical fiber 20 may be drawn from the optical fiber preform 10. The draw furnace 110 may be oriented along the fiber pathway 15, which may be a vertical pathway, such that the optical fiber 20 drawn from the optical fiber preform 10 exits the draw furnace 110 in a downward direction. By orienting the draw furnace 110 in a vertical direction, the optical fiber 20 may be drawn from the optical fiber preform 10 by the weight of the optical fiber preform 10 as the optical fiber preform 10 softens due to the temperature of the draw furnace 110 and, in some embodiments, by tension applied to the optical fiber 20, and thereby applied to the optical fiber preform 10, by the fiber collection unit 190.

After the optical fiber 20 exits the draw furnace 110, the optical fiber 20 traverses the coating station 112, which applies a first colored layer 32 to the optical fiber 20, and in some embodiments, applies one or more buffer layers, such as a first buffer layer 26 and a second buffer layer 28. First buffer layer 26 and second buffer layer 28 are also known in the art as primary and secondary coatings, respectively. For example, in embodiments comprising buffer layers, the coating station 112 may first apply the first buffer layer 26 onto the cladding 24, next apply the second buffer layer 28 onto the first buffer layer 26, and next apply the first colored layer 32 directly onto the second buffer layer 28. While a single coating station 112 is depicted in FIG. 1, it should be understood that embodiments comprising multiple coating stations are contemplated, for example, coating stations for applying each of the first buffer layer 26, the second buffer layer 28, and the first colored layer 32, respectively.

As shown in FIG. 1, the optical fiber 20 next traverses an optional drying station 114 and the first curing station 116. In some embodiments, the drying station 114 is an oven that applies heat to the first colored layer 32 and any other layers applied by the coating station 112 to dry these layers. In addition, the first curing station 116 ensures that the first buffer layer 26, the second buffer layer 28, and/or the first colored layer 32 are cured before the optical fiber 20 reaches the optical system 120. Although FIG. 1 depicts the first curing station 116 as a single process unit following the coating station 112, it is understood that in other embodiments, multiple curing stations may be present along fiber pathway 15 before the optical fiber 20 enters the optical system 120. For example, first buffer layer 26 may be applied by a coating station and cured before applying (or curing) second buffer layer 28. Second buffer layer 28 may be applied and cured before applying (or curing) first colored layer 32. First buffer layer 26 and second buffer layer 28 may be applied and cured simultaneously before applying (or curing) first colored layer 32. In each embodiment, the first colored layer 32 is cured upon entry to optical system 120 in which a laser beam 180 is directed onto the first colored layer 32. The first curing station 116 may be an ultraviolet (UV) curing station that includes UV light emitting diodes (LEDs) to cure the first colored layer 32. Alternatively, the first curing station 116 may include Hg lamps for UV curing or a heater for thermal curing.

Next, the optical fiber 20 traverses the optical system 120 where the laser beam 180 is directed onto the optical fiber 20 to form the one or more laser-modified regions 34 in the first colored layer 32. After formation of the one or more laser-modified regions 34, the optical fiber 20 traverses the ink station 150 where the second colored layer 36 is directly applied to the one or more laser-modified regions 34. Both the optical system 120 and laser formation of the one or more laser-modified regions 34 are described in more detail below with respect to FIGS. 3A-8. Furthermore, both the ink station 150 and the application of ink 152 to form the second colored layer 36 directly onto the one or more laser-modified regions 34 are described in more detail below with respect to FIGS. 9A-9C. After application of ink to form the second colored layer 36, the optical fiber 20 may traverse the optional second curing station 118, which cures the ink of the second colored layer 36. Like the first curing station 116, the second curing station 118 may be an ultraviolet (UV) curing station that includes UV light emitting diodes (LEDs) to cure the second colored layer 36. Alternatively, the second curing station 118 may include Hg lamps for UV curing or a heater for thermal curing.

Referring still to FIG. 1, after formation and processing, the optical fiber 20 may be wound onto a fiber storage spool 192 with a fiber collection unit 190. The fiber collection unit 190 utilizes drawing mechanisms and tensioning pulleys, such as a capstan 194 and a screen-testing pulley 193, to facilitate winding the optical fiber 20 onto the fiber storage spool 192. The capstan 194 may provide the necessary tension to the optical fiber 20 as the optical fiber 20 is drawn along the fiber pathway 15 and the screen-testing pulley 193 moves into and out of contact with the optical fiber 20 for tension testing/quality control. Accordingly, the fiber collection unit 190 may directly contact the optical fiber 20 in order to both wind the optical fiber 20 onto fiber storage spool 192 as well as to provide the desired tension on the optical fiber 20 as it is drawn through the draw furnace 110, the coating station 112, the drying station 114, the first curing station 116, the optical system 120, the ink station 150, and the second curing station 118.

Referring now to FIG. 2, the spool-to-spool system 102 comprises a first fiber spool 195 and a second fiber spool 196 positioned such that the fiber pathway 15 extends from the first fiber spool 195 to the second fiber spool 196. Similar to the optical fiber draw tower 101, the spool-to-spool system 102 includes the optical system 120 and the ink station 150, each positioned along the fiber pathway 15 where the optical system 120 is positioned between the first fiber spool 195 and the ink station 150. While not depicted, the spool-to-spool system 102 may further comprise a curing station, similar to the second curing station 118 of FIG. 1, that is configured to cure the ink applied by the ink station 150, which forms the second colored layer 36. The spool-to-spool system 102 facilitates the formation of laser-modified regions 34 on the first colored layer 32 of the optical fiber 20 and the application of the second colored layer 36 directly onto the first colored layer 32 during a process that is separate from the initial manufacture of the optical fiber 20 (e.g., the initial drawing process that forms the optical fiber 20 from the optical fiber preform 10 as shown in FIG. 1). In other embodiments, first buffer layer 26 and second buffer layer 28 are formed in the initial manufacture of the optical fiber 20 and first colored layer 32 is subsequently applied in a separate offline process that includes, for example, a spool-to-spool system that includes a coating station and a curing station. The optical fiber 20 so formed may then be introduced into the spool-to-spool system shown in FIG. 2 for laser modification and formation of the second colored layer 36. Alternatively, the spool-to-spool system 102 may include a coating station and a curing station positioned between first fiber spool 195 and optical system 120 so that application and curing of first colored layer 32 laser modification, and formation of second colored layer 36 occur in a single spool-to-spool process. The optical fiber draw tower 101 and the spool-to-spool system 102 are two example processing systems that facilitate the formation of laser-modified regions 34 on the first colored layer 32 of the optical fiber 20 and the application of the second colored layer 36 directly onto the first colored layer 32. However, it should be understood that the methods described herein may be applied to any processing system that includes the optical system 120 and the ink station 150.

Referring now to FIGS. 3A and 3B, the optical fiber 20 is depicted undergoing laser processing by the optical system 120 to form the one or more laser-modified regions 34 in the first colored layer 32. In particular, FIG. 3A is a schematic lengthwise cross section of the optical fiber 20 undergoing laser processing and FIG. 3B is a schematic radial cross section of the optical fiber 20 undergoing laser processing. The optical fiber 20 comprise a core 22 and a cladding 24 surrounding the core 22. The core 22 and the cladding 24 each comprises a glass material and the core 22 comprises a higher refractive index than the cladding 24. The first colored layer 32 surrounds the cladding 24. In some embodiments, as depicted in FIGS. 3A and 3B, the optical fiber 20 further comprises one or more buffer layers disposed between the cladding 24 and the first colored layer 32, such as the first buffer layer 26 and the second buffer layer 28. The first buffer layer 26 and the second buffer layer 28 may comprise a polymer material, such as acrylate, epoxy, or the like. FIGS. 3A and 3B depict the laser beam 180 output by the beam source 122 of the optical system 120 directed onto the first colored layer 32 of the optical fiber 20 such that the laser beam 180 modifies the first colored layer 32 to form the one or more laser-modified regions 34 along an outer surface 35 of the first colored layer 32.

Referring now to FIGS. 3C and 3D, a portion of the optical fiber 20 of FIGS. 3A and 3B is shown that depicts embodiments of the laser-modified region 34 formed in the first colored layer 32 in more detail. The laser-modified regions 34 include modification features 38 formed by modifying the first colored layer 32 with a laser beam. The modification features 38 correspond to deviations in the smoothness or texture of outer surface 35 relative to the unmodified portions of outer surface 35. Examples of modification features 38 include microcracks, protrusions, depressions, undulations, and combinations thereof. The modification features 38 increase the roughness and/or surface area of the portion of the outer surface 35 modified by the laser to form laser-modified regions 34. While not wishing to be bound by theory, it is believed that the increased roughness and/or surface area of laser-modified regions 34 increase adhesion of second colored layer 36 to first colored layer 32. The laser-modified regions 34 include a plurality of modification features 38, which may or may not be equal in physical dimensions and which may or may not be positioned equally spaced within laser-modified regions 34. For purposes of the present disclosure, the term “roughness” means root-mean-square roughness. In some embodiments, the roughness of the laser-modified regions 34 may be in a range of from 25 nm to 500 nm, for example 25 nm, 35 nm, 50 nm, 70 nm, 100 nm, 150 nm, 200 nm, 250 nm, 300 nm, 350 nm, 400 nm, 450 nm, 500 nm, 750 nm, 1.0 μm, 2.0 μm, 3.0 μm, up to the full thickness of the first colored layer 32, or any range having any two of those values as endpoints. Portions of the first colored layer 32 that are not laser modified have a lower roughness than the laser-modified regions 34. For example, portions of the first colored layer 32 that are not laser modified have a roughness in a range of from 20 nm to 40 nm, for example 25 nm, 30 nm, 35 nm, or any range having any two of those values as endpoints.

For example, FIG. 3C shows an embodiment of the laser-modified region 34 with modification features 38 comprising a plurality of microcracks extending into the first colored layer 32 and FIG. 3D shows an embodiment of the laser-modified region 34 with modification features 38 comprising a plurality of protrusions extending from the first colored layer 32. It should be understood that, the modification features 38 of the one or more laser-modified regions 34 may comprise a plurality of microcracks extending into the first colored layer 32, a plurality of protrusions extending from the first colored layer 32, or combinations thereof. Although depicted as equally spaced in FIGS. 3C and 3D, it is understood that the spacing between adjacent ones of the modification features 38 or the thickness of the features within laser-modified regions 34 may be the same or different. The modification features 38 within laser-modified regions 34 may be periodically arranged or randomly arranged.

As depicted in FIGS. 3C and 3D, the one or more laser-modified regions 34 comprise a thickness T of 10 μm or less. For example, the thickness T of the one or more laser-modified regions 34, or of the one or more modification features 38 formed therein, may comprise a range of from 0.2 μm to 10 μm or a range of from 0.5 μm to 10 μm, such as from 0.2 μm to 8 μm, or from 0.2 μm to 5 μm, or from 0.2 μm to 3 μm, or from 0.5 μm to 8 μm, or from 0.5 μm to 5 μm, or from 0.5 μm to 3 μm, or from 1 μm to 8 μm, or from 1 μm to 5 μm, or from 1 μm to 3 μm, for example, the thickness T may be 0.5 μm, 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, 10 μm, or any range having any of these two values as endpoints. Furthermore, the first colored layer 32 may comprise a thickness of in a range of from 1 μm to 20 μm, such as 2 μm to 10 μm. The thickness T of the one or more laser-modified regions 34 may be less than the thickness of the first colored layer 32. For example, the thickness T of the one or more laser-modified regions 34 may be less than 90% of the thickness of the first colored layer 32, for example, less than 80%, less than 70%, less than 50%, less than 30%, or a range having any of these values as endpoints. Moreover, after application of the second colored layer 36 onto the laser-modified regions 34, the outer diameter of the second colored layer 36 may be within 20% of the outer diameter of the first colored layer 32 prior to forming the laser-modified regions 34, such as within 15%, within 10%, within 5%, or within a percentage range having any two of these values as endpoints.

In some embodiments, the one or more laser-modified regions 34 are intermittently spaced along a length of the optical fiber 20 and in other embodiments the one or more laser-modified regions comprise a single, continuous laser-modified region 34 extending along the length of the optical fiber 20. In some embodiments, the one or more laser-modified regions 34 extend around an entire circumference of outer surface 35 and in other embodiments the one or more laser-modified regions 34 extend around a portion of an entire circumference of outer surface 35. The one or more laser-modified regions 34, for example, may extend around greater than 5%, or greater than 10%, or greater than 25%, or greater than 50%, or greater than 75%, or greater than 90%, or between 5% and 100%, or between 25% and 100%, or between 50% and 100%, or between 10% and 90%, or between 20% and 80% of the entire circumference of the outer surface 35. Moreover, the one or more laser-modified regions 34 may extend around the circumference of the outer surface 35 is an intermittent manner, such that the coverage of the one or more laser-modified regions 34 is not continuous. This facilitates adherence of the second colored layer 36 to the outer surface 35 in an intermittent manner, such as a striped manner.

In some embodiments, the laser beam 180 modifies the first colored layer 32 by ablation, which is the removal and/or modification of a material by laser interaction. Ablation occurs due to energy transfer from the laser beam 180 to the material of the first colored layer 32. In the embodiments described herein, the laser beam 180 ablates by non-linear absorption, which is often referred to as multi-photon absorption (MPA), linear absorption, or a combination of non-linear and linear absorption. Ablation changes the texture and the topography of the laser-modified regions 34, which include peaks and valleys due to spatially inhomogeneous material removal induced by the laser beam 180, cracks that penetrate at or below the outer surface 35, and melted and redeposited material. Without intending to be limited by theory, adhesion of the ink 152 (FIGS. 9A-9C) to the one or more laser-modified regions 34 is due to the change in the texture and the topography of the laser-modified regions 34, because the ink 152 permeates and interlocks with the modified surface of the laser-modified regions 34. For example, topography changes creates roughness in the laser-modified regions 34 that increases the contact area between the ink 152 and the laser-modified regions 34 facilitating mechanical interlocking therebetween. In addition, the ink 152 may flow into the cracks and crevasses of the laser-modified regions 34 to retain and hold the color of the ink 152 and help increase ink adhesion. Moreover, melted and redeposited material in the laser-modified regions 34 form protrusions that allow interlocking or entanglement with the ink 152 after it dries and forms the second colored layer 36—analogous to a “velcro-type” adhesion. Adhesion strength depends on both the characteristics of the laser-modified regions 34 and characteristics of the ink 152, such as ink layer thickness and viscosity.

Without intending to be limited by theory, laser modification on the outer surface 35 of the first colored layer 32 depends on the pulse duration, wavelength, repetition rate, concentration, and shape of the laser beam 180. For example, reducing the beam waist size of the laser beam 180 at the outer surface 35 increases its energy fluence and intensity, therefor increasing the ablation rate and ablated volume in the first colored layer 32. In the embodiments described herein, the energy fluence and intensity of the laser beam 180 impinging the first colored layer 32 is such that the first colored layer 32 is modified enough to promote ink adhesion without damaging or modifying the optical and mechanical properties of the optical fiber 20. In one embodiment, the attenuation of an optical signal in the optical fiber (as measured in units of dB/km e.g. at a wavelength of 1310 nm or 1550 nm) is the same before and after exposure of the first colored layer 32 to the laser beam 180. Furthermore, the first buffer layer 26 and the second buffer layer 28 are not laser modified by the laser beam 180, even in portions of the first buffer layer 26 and the second buffer layer 28 directly below the laser-modified regions 34 of the first colored layer 32.

While ablation is primarily discussed herein, other forms of laser modification are contemplated, such as severing of the first colored layer 32, modification of the surface chemistry of the first colored layer 32, such as modification of the surface tension of the first colored layer 32 or modification of the energy state of the molecules of the first colored layer 32, or densification of the first colored layer 32. Moreover, in embodiments in which the surface chemistry of the first colored layer 32 is modified, the laser-modified regions 34 comprise minimal to no thickness (i.e., the thickness T of the laser-modified regions would be at or near zero), minimizing the thickness of the second colored layer 36 needed to adhere to the first colored layer 32. Alternatively, in other embodiments, the second colored layer 36 may be applied to the first colored layer 32 before laser forming the laser-modified regions 34 on the outer surface 35 of the first colored layer 32. In this embodiment, the laser beam 180 traverses the second colored layer 36 and impinges the outer surface 35 of the first colored layer 32, depositing enough laser energy to generate a phase change on the first colored layer 32 (such as melting) or a viscosity change on the first colored layer 32, such that the ink of the second colored layer 36 can diffuse into or combine with the first colored layer 32. In this alternative embodiment, the ink station 150 may be placed upstream the optical system 120 along the fiber pathway 15 in the various processing systems described herein such that the ink of the second colored layer 36 is applied before laser processing.

Referring now to FIG. 4, the optical fiber 20 is depicted after both laser processing and ink application in an embodiment such that the optical fiber 20 comprises the first colored layer 32 having one or more laser-modified regions 34 and the second colored layer 36 surrounding the first colored layer 32. The second colored layer 36 is directly adhered to the one or more laser-modified regions 34 of the first colored layer 32. The first colored layer 32 and the second colored layer 36 each comprise a different color to provide unique visual identification for use in a cabling assembly. The one or more laser-modified regions 34 are a surface onto which the ink 152 that forms second colored layer 36 can adhere. Without the one or more laser-modified regions 34, the ink 152 will disperse and agglomerate without any adherence on the first colored layer 32, allowing the ink 152 to be easily wiped off. However, the processes described herein promote adhesion of inks 152 and existing paint composition that are standards in the optical fiber industry, such as silicone based inks including NEO 8 and NEO 9. Furthermore, the texture or surface area associated with the one or more laser-modified regions 34 may lead to differences in the reflection or scattering of visible light to provide an optical contrast relative to the unmodified portion of outer surface 35. Such optical contrast within or along the first colored layer 32 may in and of itself provide a unique visual identification, independent of and/or without application of the ink 152, that forms the second colored layer 36.

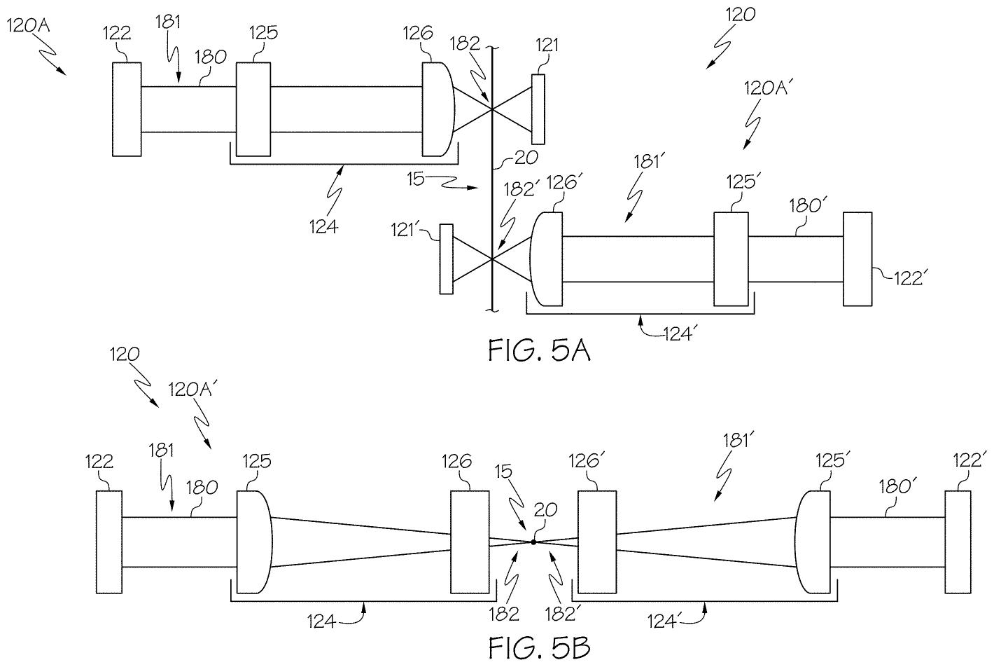

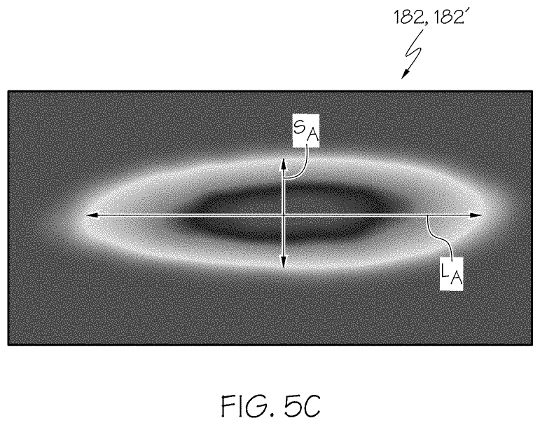

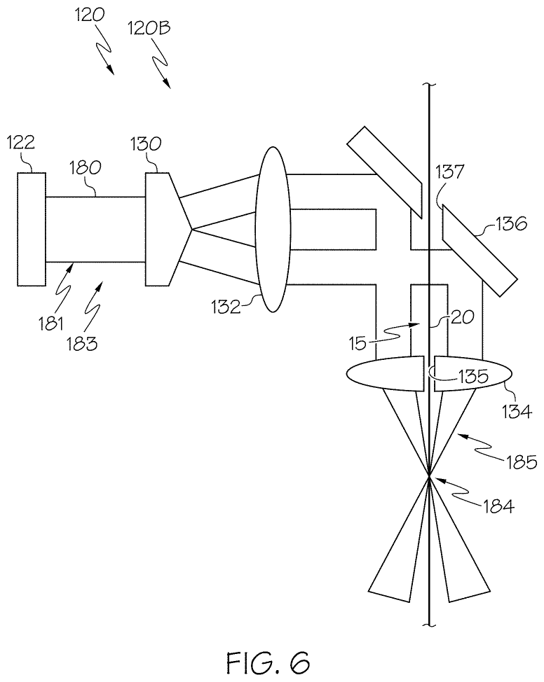

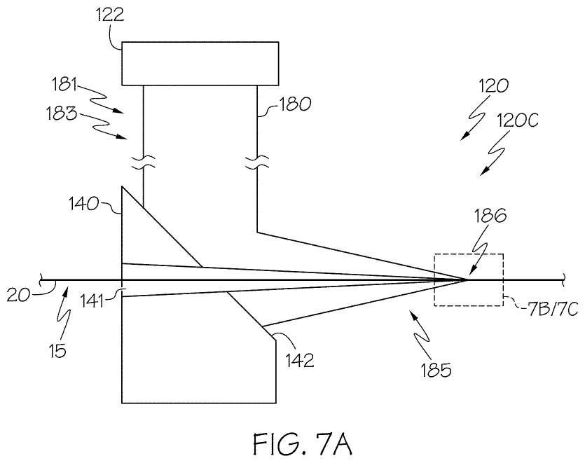

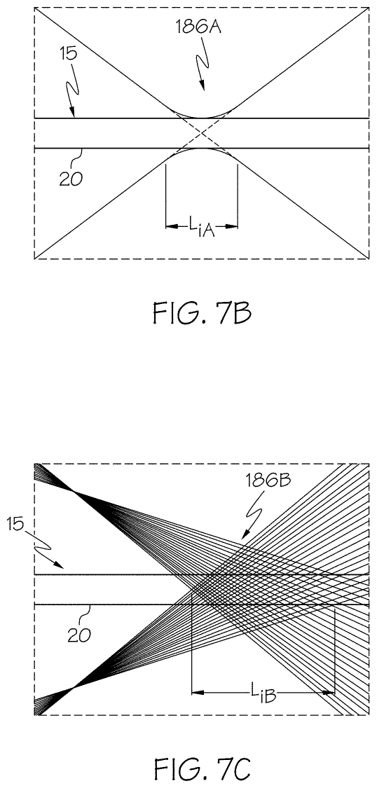

Referring now to FIGS. 5A-8, example embodiments of the optical system 120 for producing a laser beam 180 are schematically depicted. FIGS. 5A-5C depict an optical system 120A, 120A′ that comprises the beam source 122 and a cylindrical lens pair 124, 124′. FIG. 6 depicts an optical system 120B that comprises the beam source 122 and a first aspheric optical element 130. FIGS. 7A-7C depict an optical system 120C that comprises the beam source 122 and an off-axis parabolic mirror 140. FIG. 8 depicts an optical system 120D that comprises the beam source 122, the first aspheric optical element 130, a second aspheric optical element 131, and a focusing mirror 138. Some or all of the lenses, the mirrors, and the beam source 122 of the optical system 120 of FIGS. 5A-8 may be mounted on movable stages, such as galvo-scanners, linear translation stages, electro-optical devices, acousto-optical devices, or the like, to help align the optical components and steer the laser beam 180. In some embodiments, one or more sensors may be used to track the lateral position of the optical fiber 20 along the fiber pathway 15 and use the movable stages to maintain the focus of the laser beam 180 on the optical fiber 20. This may account for the natural fiber motion that occurs in the optical fiber draw tower 101 and the spool-to-spool system 102.

Each of the optical assemblies comprise the beam source 122 that outputs the laser beam 180, which may comprise a Gaussian laser beam. The beam source 122 may comprise, a gas laser, a solid state laser, a fiber laser, a semiconductor diode laser, or the like. The beam source 122 may have adjustable power up to 5 kW and adjustable repetition rate from a single shot up to 10 MHz. In some embodiments, the beam source 122 may output a laser beam 180 comprising a wavelength of, for example, 10600 nm, 9300 nm, 1064 nm, 1030 nm, 532 nm, 530 nm, 355 nm, 343 nm, or 266 nm, or 215 nm.

In some embodiments, the laser beam 180 emitted by the beam source 122 is pulsed and comprises short light pulses (e.g., in the range from femtoseconds to microseconds) or pulse bursts having a closely spaced series of sub-pulses. Pulsed versions of the laser beam 180 may comprise a pulse duration ranging from a few nanoseconds to tens of microseconds. Moreover, the beam source 122 may simultaneously generate multiple pulsed beams having different phases. In some embodiments, the laser beam 180 emitted by the beam source 122 is a continuous wave laser beam. Without intending to be limited by theory, embodiments comprising a continuous wave laser beam are emitted with more laser energy than the pulsed laser beams because the energy is temporally spread over a much longer period than the sharp intensity provided by a pulsed laser beam.

Without intending to be limited by theory, the energy transfer to the first colored layer 32 depends on how much of the energy of the laser beam 180 is absorbed by the first colored layer 32 and, in some embodiments, the second buffer layer 28, in the linear absorption regime and non-linear absorption regime. In the linear absorption regime, the amount of laser energy that is transferred to the first colored layer 32 to modify the first colored layer 32 (i.e., to form the one or more laser-modified regions 34) is dependent on the absorption curve of the material of the first colored layer 32 and, in some embodiments, the absorption curve of the adjacent buffer layer (e.g., the second buffer layer 28) relative to the wavelength of the laser beam 180. Since the ink colors used in first colored layer 32 are in the visible range of the electromagnetic spectrum, it may be useful to use wavelengths in the visible range, such as a 532 nm laser, to increase linear absorption. High levels of linear absorption are also achievable at ultraviolet wavelengths, such as 355 nm, and infrared wavelengths such as wavelengths in a range of from 9 μm to 10 μm.

Referring now to FIGS. 5A-5C, the optical system 120A will be described in more detail. FIG. 5A is a schematic side view of the optical system 120A and FIG. 5B is a schematic top view of the optical system 120A, while FIG. 5C depicts a laser beam focus 182 formed using the optical system 120A. The optical system 120A comprises the cylindrical lens pair 124, which includes a first cylindrical lens 125 and a second cylindrical lens 126 positioned between and optically coupled to the beam source 122 and the fiber pathway 15. In other words, the second cylindrical lens 126 is downstream the first cylindrical lens 125 along a laser pathway 181 and the second cylindrical lens 126 is upstream the fiber pathway 15, which intersects the laser pathway 181 such that the laser beam 180 may be directed onto the optical fiber 20 when the optical fiber 20 is traversing the fiber pathway 15. As used herein, “upstream” and “downstream” refer to the relative position of two locations or components along a laser pathway with respect to a beam source. For example, a first component is upstream from a second component if the first component is closer to the beam source 122 along the laser pathway 181 traversed by the laser beam 180 than the second component.

In operation, a cylindrical lens, such as the first and second cylindrical lenses 125, 126, widens the laser beam focus 182 of the laser beam 180. Without intending to be limited by theory, a single cylindrical lens focuses the laser beam 180 in one direction orthogonal to the laser pathway 181, that is, orthogonal to the beam propagation direction (e.g., a first orthogonal direction) without affecting the beam in another direction orthogonal to the laser pathway 181 (e.g., a second orthogonal direction, which is also orthogonal to the first orthogonal direction). However, for many lasers, modification by a single cylindrical lens would not form an energy density at the laser beam focus 182 large enough to modify (e.g., ablate) the first colored layer 32 of the optical fiber 20. Thus, in the optical system 120A, the first cylindrical lens 125 is rotated 90° about a laser pathway 181 with respect to the second cylindrical lens 126 to further widen the laser beam focus 182. Indeed, as shown in FIG. 5C, the cylindrical lens pair 124 produces a laser beam focus 182 comprising a short axis S_{A} orthogonal a long axis L_{A}, where the long axis L_{A} is longer than the short axis S_{A}, such as 10 or more times longer than the short axis S_{A}. For example, the long axis L_{A} may be 5 or more times longer than the short axis S_{A}. This increases the energy density of the laser beam focus 182 along the short axis S_{A} and thus, by orienting the short axis S_{A} along the fiber pathway 15, this increased energy density is directed onto the outer surface 35 of the optical fiber 20. Moreover, by orienting the long axis L_{A} orthogonal to fiber pathway 15, it is possible to modify half the circumference of the outer surface 35 of the optical fiber (i.e., modify a “hemisphere” of the outer surface 35 of the optical fiber 20) in a single laser impingement, while providing tolerance for some lateral motion of the optical fiber 20 as the optical fiber traverses the fiber pathway 15. Moreover, due to lensing effects caused by the first colored and/or buffer layers of the optical fiber 20, the laser beam focus 182 may modify more than one half of the circumference of the optical fiber 20, extending the laser-modified regions 34 further around the circumference of the optical fiber 20. Indeed, the geometric shape of the optical fiber 20, it acts as a lens and refocuses light absorbed by the first colored layer 32 upon initial impingement and ablation.

In some embodiments, as depicted in FIGS. 5A and 5B, the optical system 120A is a first optical system 120A and the optical system 120 further comprises a second optical system 120A′. In this embodiment, the beam source 122 is a first beam source 122, the laser beam 180 output by the first beam source 122 is a first laser beam 180, and the cylindrical lens pair 124 is a first cylindrical lens pair 124. Furthermore, the second optical system 120A′ comprises a second beam source 122′ configured to output a second laser beam 180′ and a second cylindrical lens pair 124′ comprising a first cylindrical lens 125′ and a second cylindrical lens 126′. The first cylindrical lens 125′ is rotated 90° about a second laser pathway 181′ with respect to the second cylindrical lens 126′. In operation, the first laser beam 180 is directed onto a first hemisphere 41 (FIG. 4) of the first colored layer 32 and the second laser beam 180′ is directed onto a second hemisphere 42 (FIG. 4) of the first colored layer 32, such that the second laser beam 180′, for example, the second laser beam focus 182′ modifies the first colored layer 32 to form laser-modified regions 34 on the second hemisphere 42 of the first colored layer 32. As shown in more detail in FIG. 4, the first hemisphere 41 of the first colored layer 32 is opposite the second hemisphere 42 of the first colored layer 32 and the first hemisphere 41 is depicted as separated from the second hemisphere 42 by a radial centerline 40. Thus, using the first laser beam 180 and the second laser beam 180′, the one or more laser-modified regions 34 may be formed around the entire circumference of the first colored layer 32. Moreover, while FIGS. 5A and 5B describe laser modification of the first colored layer 32 using two laser beams 180, 180′, it should be understood that laser modification of the first colored layer 32 may be performed by more than two laser beams, which may each impinge the first colored layer 32 simultaneously.

Referring now to FIG. 6, the optical system 120B comprises a first aspheric optical element 130, such as an axicon lens positioned along a first segment 183 of the laser pathway 181 between the beam source 122 and a mirror 136, such as a folding mirror. The mirror 136 optically couples the first segment 183 of the laser pathway 181 with a second segment 185 of the laser pathway 181. In some embodiments, the first segment 183 of the laser pathway 181 is orthogonal to the second segment 185 of the laser pathway 181. Furthermore, the second segment 185 of the laser pathway 181 is collinear with the fiber pathway 15. Indeed, the fiber pathway 15 extends through a hole 137 in the mirror 136 such that the optical fiber 20 may travel along the second segment 185 of the laser pathway 181 and pass through the hole 137. As described in more detail below, this allows the laser beam 180 to impinge the entire circumference of the optical fiber 20.

Referring still to FIG. 6, the optical system 120B further comprises a first lens 132 positioned along the first segment 183 of the laser pathway 181 between the first aspheric optical element 130 and the mirror 136 and a second lens 134 positioned along the second segment 185 of the laser pathway 181, downstream the mirror 136. As the second lens 134 is positioned within the second segment 185 of the laser pathway 181, which is collinear with the fiber pathway 15, the second lens 134 comprises a hole 135 aligned with both the second segment 185 of the laser pathway 181 and the fiber pathway 15, such that the optical fiber 20 may extend through the hole 135 in the second lens 134. In operation, the first lens 132 collimates the laser beam 180 between the first lens 132 and the second lens 134 and the second lens 134 may focus the laser beam 180, for example, onto the optical fiber 20. In some embodiments, the first lens 132 and the second lens 134 each comprise plano-convex lenses. When the first lens 132 and the second lens 134 each comprise plano-convex lenses, the curvature of the first lens 132 and the second lens 134 may each be oriented toward the mirror 136. In other embodiments, the first lens 132 may comprise other collimating lenses and the second lens 134 may comprise a meniscus lens, an asphere, or another higher-order corrected focusing lens. Moreover, it should be understood that some embodiments may not include the first lens 132 and the second lens 134 and instead, the first aspheric optical element 130 may focus the laser beam 180 off the mirror 136 and thereafter directly onto the optical fiber 20.

In some embodiments, the first aspheric optical element 130 comprises a conical wavefront producing optical element, such as an axicon lens, which may be a negative refractive axicon lens (e.g., negative axicon), a positive refractive axicon lens, a reflective axicon lens, a diffractive axicon lens, a phase axicon, or the like. In operation, propagating the laser beam 180, e.g., an incoming Gaussian beam, through the first aspheric optical element 130 may alter, for example, phase alter, the laser beam 180 such that the portion of the laser beam 180 propagating downstream the first aspheric optical element 130 is a quasi-non-diffracting beam of the Bessel type. A detailed description of the formation of quasi-non-diffracting beams of the Bessel type and determining their length, is provided in U.S. Pat. No. 10,730,783, which is incorporated by reference in its entirety. In the unfocused space, the quasi-non diffracting beam has an annular shape (e.g., a ring shape). A tight focus in the transverse direction (e.g., a laser beam focus 184) is attainable and it extends over a longer region along the laser pathway 181 (i.e., the beam axis) and along the outer surface 35 of first colored layer 32 than a focused Gaussian beam, such as the laser beam focus 182, 182′.

In operation, the light annulus can be focused with a lens and therefore it is possible to make the light converge from all directions with equal intensity. As shown in FIG. 6, the first aspheric optical element 130 generates a diverging annulus of light that is quasi-non-diffracting of the Bessel type. The first lens 132 collimates the annulus, the mirror 136 directs the collimated annulus along the second segment 185 of the laser pathway 181, collinear with the fiber pathway 15, and the second lens 134 re-images (e.g., focuses) the quasi-non-diffracting Bessel type onto the fiber pathway 15. Thus, the optical fiber 20 may be impinged by the laser beam 180 along its entire circumference in a single impingement. However, due to the nature of the quasi-non-diffracting Bessel type beam, a more powerful laser might be needed when compared to the optical system 120A of FIGS. 5A-5C since the energy is distributed over a larger volume compared to a Gaussian beam, as shown in FIGS. 7B and 7C, described below.

Referring now to FIGS. 7A-7C, the optical system 120C comprises an off-axis parabolic mirror 140 optically coupled to the beam source 122 and optically coupling the first segment 183 of the laser pathway 181 with the second segment 185 of the laser pathway 181. Similar to the optical system 120B, the second segment 185 of the laser pathway 181 is collinear with the fiber pathway 15. Furthermore, the first segment 183 of the laser pathway 181 is orthogonal with the second segment 185 of the laser pathway 181. Similar to the mirror 136 of the optical system 120B, the off-axis parabolic mirror 140 comprises a hole 141 aligned with the fiber pathway 15 such that the fiber pathway 15 extends through the hole 141 and the optical fiber 20 may be translated through the hole 141. In operation, the off-axis parabolic mirror 140 focuses the laser beam 180 in a direction perpendicular to the direction in which the laser beam 180 impinges the off-axis parabolic mirror 140. Similar to the optical system 120B, the optical system 120C directs the laser beam 180 onto the entire whole circumference of the optical fiber 20.

The laser beam focus 186 formed using the off-axis parabolic mirror 140 may comprise a Gaussian laser beam focus 186A, as shown in FIG. 7B, which resembles the focus formed using a traditional spherical lens (similar to the second laser beam focus 182′ of FIGS. 5A-5C). However, in some embodiments, the first aspheric optical element 130 of FIG. 6 may be positioned between the beam source 122 and the off-axis parabolic mirror 140 such that the laser beam focus formed using the off-axis parabolic mirror 140 comprises a Bessel laser beam focus 186B (similar to the laser beam focus 184 of FIG. 6). FIG. 7B schematically depicts the length of interaction L_{iA} between the Gaussian laser beam focus 186A and the optical fiber 20, which is the length along the optical fiber 20 in which the Gaussian laser beam focus 186A induces linear and/or non-linear absorption in the first colored layer 32. FIG. 7C schematically depicts the length of interaction L_{iB} between the Bessel laser beam focus 186B and the optical fiber 20, which is the length along the optical fiber 20 in which the Bessel laser beam focus 186B induces linear and/or non-linear absorption in the first colored layer 32. Due to the nature of the quasi-non-diffracting Bessel type beam that forms Bessel laser beam focus 186B, the length of interaction L_{iB} of the Bessel laser beam focus 186B is longer than the length of L_{iA} of the Gaussian laser beam focus 186A, thus, a more powerful laser may be needed when compared to the optical system 120A of FIGS. 5A-5C since the energy is distributed over a larger volume compared to a Gaussian beam.

Referring now to FIG. 8, the optical system 120D comprises the first aspheric optical element 130 and a second aspheric optical element 131 positioned along the first segment 183 of the laser pathway 181 between the beam source 122 and the mirror 136, which optically couples the first segment 183 of the laser pathway 181 with the second segment 185 of the laser pathway 181. The optical system 120D further comprises a focusing mirror 138 positioned along the second segment 185 of the laser pathway 181 downstream the mirror 136. Similar to the optical system 120B (FIG. 6), the first segment 183 of the laser pathway 181 is orthogonal to the second segment 185 of the laser pathway 181. Furthermore, the second segment 185 of the laser pathway 181 is collinear with the fiber pathway 15. The fiber pathway 15 extends through the hole 137 in the mirror 136 and a hole 139 in the focusing mirror 138 such that the optical fiber 20 may travel along the second segment 185 of the laser pathway 181 and pass through the hole 137 and the hole 139. The hole 139 is collinear with the fiber pathway 15 and is aligned with the second segment 185 of the laser pathway 181, the fiber pathway 15, and the hole 137 of the mirror 136. As described in more detail below, this allows the laser beam 180 to impinge the entire circumference of the optical fiber 20.

Similar to the first aspheric optical element 130, the second aspheric optical element 131 comprises a conical wavefront producing optical element, such as an axicon lens, which may be a negative refractive axicon lens (e.g., negative axicon), a positive refractive axicon lens, a reflective axicon lens, a diffractive axicon lens, a phase axicon, diffractive optical element, or the like. In operation, propagating the laser beam 180, e.g., an incoming Gaussian beam, through the first aspheric optical element 130 may alter, for example, phase alter, the laser beam 180 such that the portion of the laser beam 180 propagating downstream the first aspheric optical element 130 is a quasi-non-diffracting beam of the Bessel type. Moreover, the second aspheric optical element 131 may be oriented such that its conical end faces the conical end of the first aspheric optical element 130 and thus the second aspheric optical element 131 collimates the quasi-non-diffracting beam. For example, the first aspheric optical element 130 may comprise a concave axicon and the second aspheric optical element 131 may comprise a convex axicon. Furthermore, the first aspheric optical element 130 and the second aspheric optical element 131 may be replaced by a single monolithic optical element with a concave conical surface at an upstream surface (e.g., input surface), which replaces the first aspheric optical element 130, and a convent conical surface at a downstream surface (e.g., output surface), which replaces the second aspheric optical element 131. In the unfocused space, the quasi-non diffracting beam has an annular shape (e.g., a ring shape). A tight focus in the transverse direction (e.g., a laser beam focus 188) is attainable and it extends over a longer region along the laser pathway 181 (i.e., the beam axis) and along the outer surface 35 of first colored layer 32 than a focused Gaussian beam, such as the laser beam focus 182, 182′ (FIG. 5C).

In operation, the light annulus can be focused with the focusing mirror 138 and therefore it is possible to make the light converge from all directions with equal intensity. As shown in FIG. 8, the first aspheric optical element 130 generates a diverging annulus of light that is quasi-non-diffracting of the Bessel type. The second aspheric optical element 131 collimates the annulus, the mirror 136 directs the collimated annulus along the second segment 185 of the laser pathway 181, collinear with the fiber pathway 15, and the focusing mirror 138 redirects and re-images (e.g., focuses) the quasi-non-diffracting Bessel type onto the fiber pathway 15. Indeed, the focusing mirror 138 redirects the laser beam 180 such that the laser beam focus 188 forms between the mirror 136 and the focusing mirror 138 and the optical fiber 20 may be impinged by the laser beam 180 along its entire circumference in a single impingement. However, due to the nature of the quasi-non-diffracting Bessel type beam, a more powerful laser might be needed when compared to the optical system 120A of FIGS. 5A-5C since the energy is distributed over a larger volume compared to a Gaussian beam.

Referring again to FIGS. 5A-8, in any of the embodiments described herein, the laser beam 180 may comprise a pulsed laser beam comprising single pulses or pulse bursts having 2 sub-pulses per pulse burst or more. In some embodiments, the pulsed laser beam comprises a pulse burst having from 2 sub-pulses to 30 sub-pulses, such as from 2 sub-pulses to 25 sub-pulses, from 2 sub-pulses to 20 sub-pulses, from 2 sub-pulses to 25 sub-pulses, from 2 sub-pulses to 12 sub-pulses, from 2 sub-pulses to 10 sub-pulses, from 2 sub-pulses to 8 sub-pulses, from 2 sub-pulses to 5 sub-pulses or any range having any two of these values as endpoints. A pulse burst is a short and fast grouping of sub-pulses (i.e., a tight cluster of sub-pulses, such as sub-pulses that are emitted by the beam source 122 and interact with the material (i.e. MPA in the material of the optical fiber 20, particularly the first colored layer 32 and the second buffer layer 28). While not intending to be limited by theory, if the laser beam 180 is directed onto the optical fiber 20 as a pulse burst and a time between temporally adjacent sub-pulses is equal to or less than the rate of thermal diffusion in the first colored layer 32, then the temperature rise in the first colored layer 32 from subsequent sub-pulses is additive. This additive temperature rise may increase the multi-photon absorption imparted by the laser beam 180 and reduce unwanted nonlinear effects.

Furthermore, each pulse burst may comprise a burst duration (i.e., a time between the start of first sub-pulse in the pulse burst and the end of the final sub-pulse in pulse burst) of from 10 ps to 500 ns, such as from 3 ns to 50 ns. In addition, each pulse burst may have a sub-pulse separation between temporally adjacent sub-pulses of from 1 ps to 50 ns, such as from 10 ns to 30 ns. Moreover, each pulse burst may comprise a repetition rate of from 100 kHz to 1500 kHz, such as 200 kHz, 300 kHz, 400 kHz, 500 kHz, 600 kHz, 700 kHz, 800 kHz, 900 kHz, 1000 kHz, 1100 kHz, 1200 kHz, 1300 kHz, 1400 kHz or any range having any two of these value as endpoints. Without intending to be limited by theory, by increasing the burst duration, while still retaining a time between temporally adjacent sub-pulses low enough to generate multi-photon absorption and a fast temperature rise in the first colored layer 32, more power can be delivered to the first colored layer 32 while minimizing or even avoiding unwanted nonlinear effects. The repetition rate of the laser beam 180 may correspond to the translation speed of the optical fiber 20 along the fiber pathway 15, such that pulse overlap during laser processing results in homogenous treatment of the outer surface 35 of the first colored layer 32. The translation speed of the optical fiber 20 may be from 1 m/s to 100 m/s, or from 2 m/s to 80 m/s, or from 5 m/s to 60 m/s, or from 10 m/s to 50 m/s. If the pulses or sub-pulses of the laser beam 180 impinge the outer surface 35 with too little overlap, there may be less ablation and less surface modification, such that ink adhesion onto the resultant laser-modified regions 34 is weak. Alternatively, if the pulses or sub-pulses impinge the outer surface 35 with too much overlap, too much damage and more heat accumulation may occur leading to unwanted melting and damage to the optical and mechanical properties of the optical fiber 20.

Referring now to FIGS. 9A-9C, embodiments of the ink station 150 of the processing system 100 for applying ink 152 to the one or more laser-modified regions 34 of the first colored layer 32 to form the second colored layer 36. As used herein, the term “ink” refers to inks, paints, pigments, dyes, and other coloring agents known in the art. FIG. 9A depicts a jetting ink station 150A configured to direct the ink 152 onto the one or more laser-modified regions 34. FIGS. 9B and 9C depict a flexographic ink station 150B configured to apply the ink 152 onto the one or more laser-modified regions 34. It should be understood that while FIGS. 9A-9C show some example ink stations 150, any known (e.g. rotogravure) or yet to be developed ink station configured to apply ink to an optical fiber may be used.

As shown in FIG. 9A, the jetting ink station 150A comprises a print head 155, a pump 154, a piezoelectric oscillator 156, a nozzle 158, charging electrodes 160, deflection electrodes 162, and gutter 164. In operation, pressurized ink 152 is supplied to the print head 155 where it is fed to the nozzle 158 which has the piezoelectric oscillator 156 and a discharge hole 159. The ink 152 is discharged while being oscillated by the piezoelectric oscillator 156, and it is simultaneously given a negative electrostatic charge by two charging electrodes 160. The ink 152 is formed into an ink column, but when saturated with the negative charge, the ink 152 becomes particles, and those particles separate from the ink column. The ink particles that discharge from the nozzle 158 pass between two deflection electrodes 162 where an electrical field selectively generated by an applied voltage to apply a bending force on the ink particles to change the direction they travel to selectively direct the ink 152 towards the fiber pathway 15 for application onto the optical fiber 20 or direct the ink to the gutter 164, where the ink 152 may be collected for reuse.

As shown in FIG. 9B, the flexographic ink station 150B comprises a fountain roller 153 partially positioned in an ink tray 151 which houses the ink 152. The fountain roller 153 is adjacent an anilox roller 170 such that ink 152 may be transferred from the fountain roller 153 to the anilox roller 170. As shown in FIG. 9B, a doctor blade 172 removes a select portion of the ink 152 from the anilox roller 170. A plate cylinder 174 is adjacent the anilox roller 170 and comprises a flexo-plate 175 that contacts the plate cylinder 174 to transfer the ink 152 to the flexo-plate 175. As shown in more detail in FIG. 9C, ink 152 may be disposed in one or more pockets 171 of the anilox roller 170 and when the flexo-plate 175 contacts the plate cylinder 174, some of the ink 152 is transferred from the pockets 171 to the flexo-plate 175 Referring again to FIG. 9B, an impression cylinder 176 is positioned adjacent the plate cylinder 174 and the fiber pathway 15 extends between the plate cylinder 174 and the impression cylinder 176 such that the optical fiber 20 passes through the flexo-plate 175 and the impression cylinder 176 and the flexo-plate 175 applies the ink 152 to the optical fiber 20 to form the second colored layer 36.

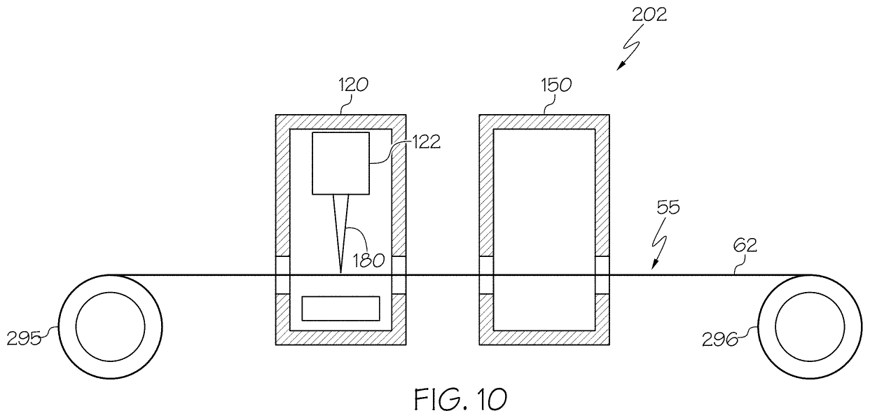

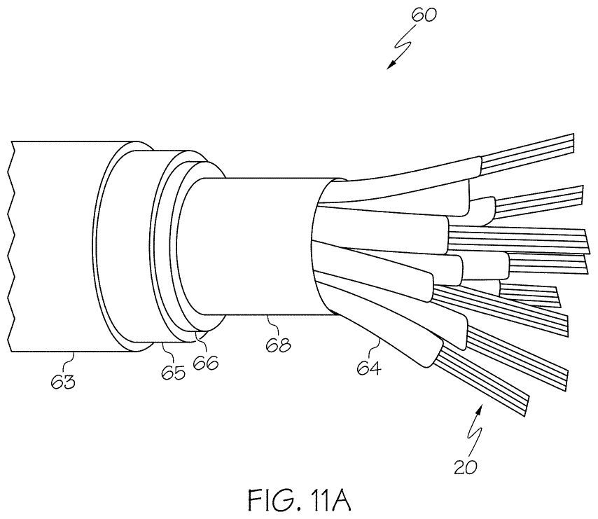

Referring now to FIG. 10, a spool-to-spool system 202 configured to process a fiber bundle support 62 is schematically depicted. As used herein, a “fiber bundle support” refers to a hollow support structure for housing multiple optical fibers, such as one or more bundles of optical fibers. Example fiber bundle supports include cable jackets and ribbon jackets. FIG. 11A depicts a cable assembly 60 that includes fiber bundle supports in the form of an inner cable jacket 64 configured to house a bundle of optical fibers 20 and an outer cable jacket 63 configured to house a plurality of inner cable jackets 64 (and thus houses multiple numbers of optical fibers 20). As shown in FIG. 11A, the cable assembly 60 may further comprise strength members (e.g., a first strength member 65 and a second strength member 66) and a buffer tube 68. The strength members 65, 66 surround the buffer tube 68. The plurality of inner cable jackets 64 may each house bundles of optical fiber 20 may be surrounded by the buffer tube 68.

Similar to the spool-to-spool system 102 of FIG. 2, the spool-to-spool system 202 of FIG. 10 comprises a first spool 295 and a second spool 296 positioned such that a fiber bundle support pathway 55 extends from the first spool 295 to the second spool 296. The optical system 120 is positioned along the spool-to-spool system 202. The spool-to-spool system 202 may comprise any of the optical systems described herein and may operate to form one or more laser-modified regions in a first colored layer of the fiber bundle support 62 using any of the techniques described above. Moreover, the spool-to-spool system 202 comprises the ink station 150, which may comprise any of the ink stations described herein and may operate to apply a second ink layer directly to the one or more laser-modified regions to form the second colored layer onto the one or more laser-modified regions. As shown in FIG. 10, the optical system 120 is positioned along the fiber bundle support pathway 55 between the first spool 295 and the ink station 150 and the ink station 150 is positioned along the fiber bundle support pathway 55 between the optical system 120 and the second spool 296.

A schematic cross section of an outer cable jacket 63 processed by the spool-to-spool system 202 of FIG. 10 is shown in FIG. 11B. As noted above, the outer cable jacket 63 is an example fiber bundle support. The outer cable jacket 63 comprises a first colored layer 72 and a second colored layer 76. The first colored layer 72 comprises one or more laser-modified regions 74 comprising modification feature 78 formed on an outer surface 75 of the first colored layer 72 using the optical system 120, and the second colored layer 76 is directly adhered to one or more laser-modified regions 74. The first colored layer 72 surrounds an opening 79 within which a bundle of optical fibers 20 may be housed. The processing system of FIG. 10 facilitates the adherence of the second colored layer 76 directly onto the first colored layer 72 to increase the number of color-coded identifications of bundles of optical fibers in a cable assembly. Indeed, the individual optical fibers 20 bundled and housed in a fiber bundle support that is laser marked, such as the outer cable jacket 63, may also be laser marked using the embodiments described herein, to provide further visual identifiers.

In view of the foregoing description, it should be understood that the methods and systems for processing optical fibers and fiber bundle supports using laser-based systems and processes enable the application and adhesion of a second colored layer directly over a first colored layer of an optical fiber or an optical fiber support to enable an increase in the number of color-coded identifications of individual optical fibers and bundles of optical fibers in a cable assembly. Using the methods and system of the present disclosure described herein may be used to directly apply distinctive color markings may be applied directly onto an existing colored ink layer to make optical fibers and fiber bundle supports distinguishable to an in-field installation technician.

### Examples

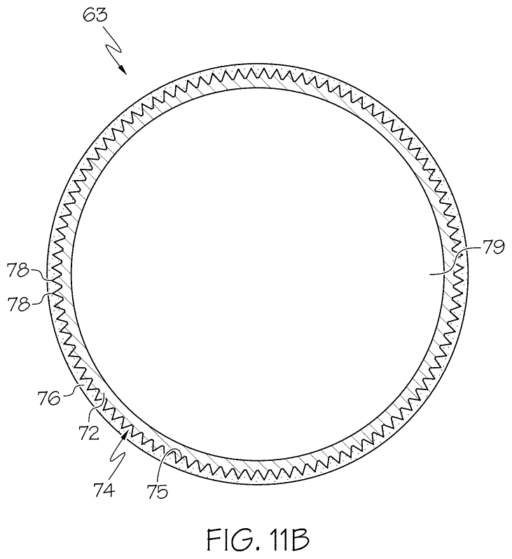

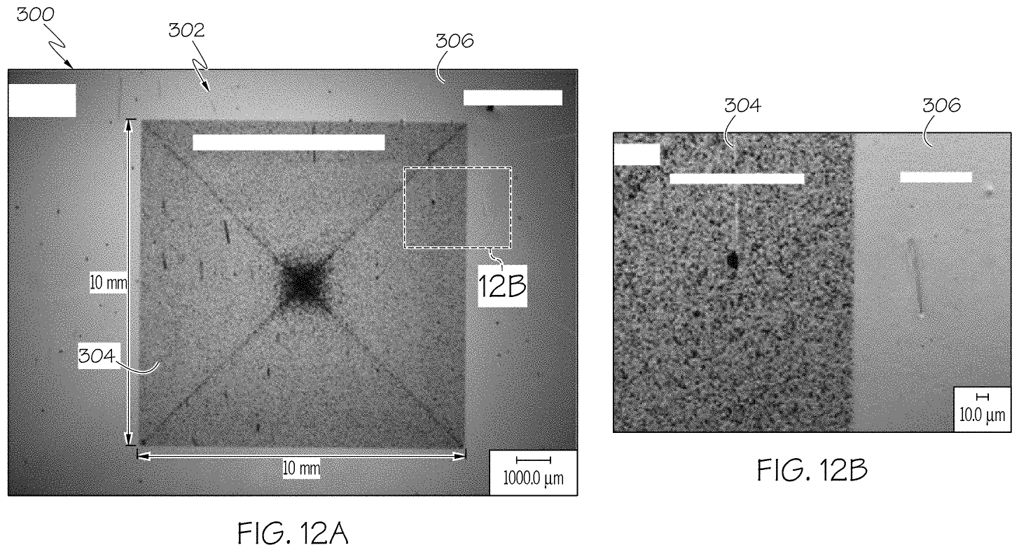

FIGS. 12A and 12B depict a glass sample 300 having a first ink layer 302 comprising NEO 9 ink that is laser modified in a first region 304 and is not laser modified in a second region 306. The first ink layer 302 is laser modified in the first region 304 using a pulsed laser beam having a pulse rate of from 3 ns to 20 ns, a wavelength of 532 nm, adjustable power (up to 40 watts), adjustable repetition rate (single shot to 1500 kHz) with the laser beam being shaped and focused onto the first ink layer 302 using an f-theta lens having a 100 mm focal length of 100 mm). The laser beam ablates the first region 304 of the first ink layer 302, increasing the roughness of the first region 304 relative to the second region 306.

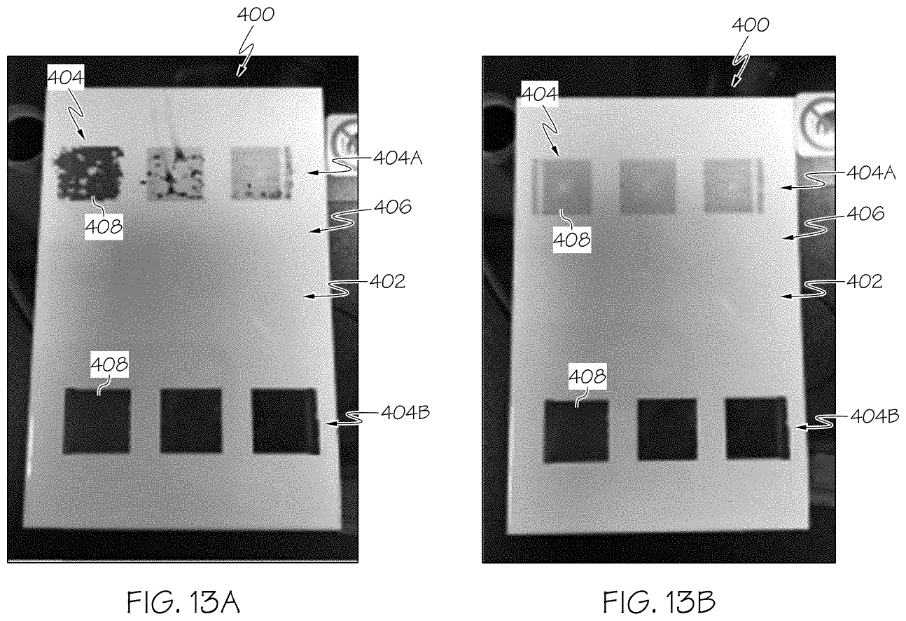

FIGS. 13A and 13B depict a glass sample 400 having a first ink layer 402 comprising NEO 9 ink that is laser modified in modified regions 404 and is not laser modified in an unmodified region 406. The modified regions 404 include a first set of modified regions 404A and a second set of modified regions 404B. The second set of modified regions 404B are laser modified with a laser beam comprising double the power of the laser beam used to laser modify the first set of modified regions 404A. FIGS. 13A and 13B also depict a second ink layer 408 applied to the modified regions 404. In FIG. 13A, the second ink layer 408 is applied to the modified regions 404 but has not yet been wiped. In FIG. 13B, the second ink layer 408 has been wiped. As shown in FIG. 13B, the second ink layer 408 adheres to the modified regions 404. Moreover, relative ink adherence between the first set of modified regions 404A and the second set of modified regions 404B show that increased laser power (and thus increased ablation) forms laser-modified regions that adhere more ink, as the roughness of the second set of modified regions 404B is greater than the first set of modified regions 404A.

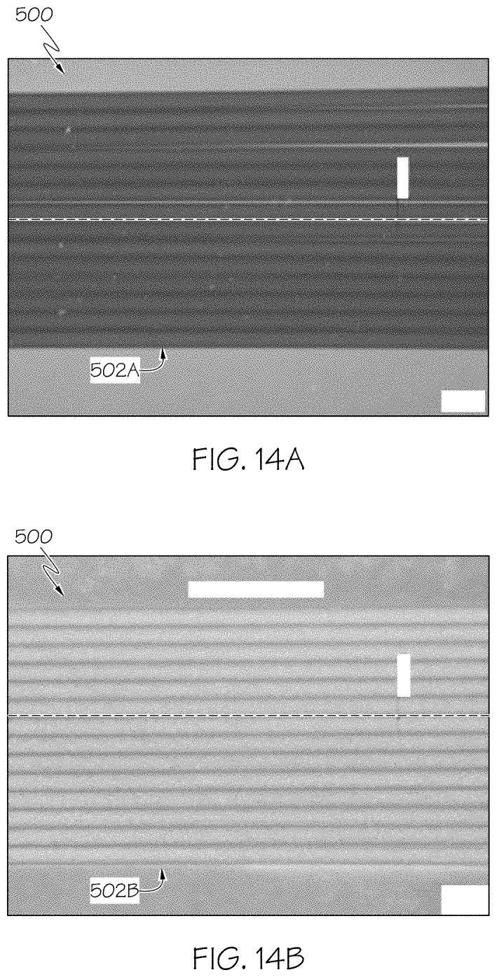

FIGS. 14A and 14B show the visual effects of laser modification on a single colored layer of ink. FIG. 14A depicts a plurality of optical fibers 500 having a first ink layer 502A that has not been laser modified and FIG. 14B depicts the plurality of optical fibers 500 after laser modification such that the first ink layer 502A now comprises a modified first ink layer 502B. As shown in FIGS. 14A and 14B, the first ink layer 502A and the modified first ink layer 502B are visually different, which is due to a difference in optical reflectivity and scattering of visible light between the first ink layer 502A and the modified first ink layer 502B caused by the increased roughness of the modified first ink layer 502B.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of marking an optical fiber, the method comprising:
directing a laser beam onto a first colored layer of an optical fiber, wherein:
the optical fiber comprises a core and a cladding surrounding the core;
the first colored layer surrounds the cladding; and
the laser beam modifies the first colored layer to form one or more laser-modified regions along an outer surface of the first colored layer.

2. The method of claim 1, wherein the one or more laser-modified regions of the outer surface comprise a plurality of microcracks extending into the first colored layer, a plurality of protrusions extending from the first colored layer, or combinations thereof.

3. The method of claim 1, wherein:
the one or more laser-modified regions comprise a thickness of from 0.2 μm to 3 μm; and
the one or more laser-modified regions comprise a thickness less than a thickness of the first colored layer.

4. The method of claim 1, further comprising translating the optical fiber along a fiber pathway while directing the laser beam onto the first colored layer of the optical fiber.

5. The method of claim 1, wherein:
the laser beam is output by a beam source of an optical system and directed to the first colored layer along a laser pathway, the optical system comprising a first cylindrical lens and a second cylindrical lens positioned along the laser pathway between the beam source and the first colored layer; and
the first cylindrical lens is rotated 90° about the laser pathway with respect to the second cylindrical lens.

6. The method of claim 1, wherein the laser beam is output by a beam source of an optical system along a laser pathway, the optical system comprising an aspheric optical element positioned along a first segment of the laser pathway between the beam source and a mirror, wherein:
the mirror optically couples the first segment of the laser pathway with a second segment of the laser pathway;
the first segment of the laser pathway is orthogonal with the second segment of the laser pathway;
the second segment of the laser pathway is collinear with a fiber pathway along which the optical fiber is positioned; and
the fiber pathway extends through a hole in the mirror.

7. The method of claim 1, wherein the laser beam is output by a beam source of an optical system, the optical system comprising an off-axis parabolic mirror optically coupled to the beam source and optically coupling a first segment of a laser pathway with a second segment of the laser pathway, wherein:
the first segment of the laser pathway is orthogonal with the second segment of the laser pathway;
the second segment of the laser pathway is collinear with a fiber pathway along which the optical fiber is positioned; and
the fiber pathway extends through a hole in the off-axis parabolic mirror.

8. The method of claim 1, wherein the laser beam is output by a beam source of an optical system along a laser pathway, the optical system comprising a first aspheric optical element and a second aspheric optical element positioned along a first segment of the laser pathway between the beam source and a mirror, wherein:
the mirror optically couples the first segment of the laser pathway with a second segment of the laser pathway;
a focusing mirror is positioned along the second segment of the laser pathway downstream the mirror;
the first segment of the laser pathway is orthogonal with the second segment of the laser pathway;
the second segment of the laser pathway is collinear with a fiber pathway along which the optical fiber is positioned; and
the fiber pathway extends through a hole in the mirror and a hole in the focusing mirror.

9. The method of claim 1, further comprising applying an ink to the one or more laser-modified regions of the outer surface of the first colored layer to form a second colored layer directly adhered to the one or more laser-modified regions of the first colored layer.

10. The method of claim 1, wherein the outer surface of the first colored layer comprises a portion not modified by the laser beam adjacent to the one or more laser-modified regions, the portion and the one or more laser-modified regions differing in a reflection or a scattering of visible light to provide an optical contrast of the portion relative to the one or more laser-modified regions.

11. The method of claim 1, wherein the outer surface of the first colored layer comprises a portion not modified by the laser beam adjacent to the one or more laser-modified regions, the one or more laser-modified regions having a higher root-mean-square roughness than the portion.

12. A method of marking a fiber bundle support, the method comprising:
directing a laser beam onto a first colored layer of a fiber bundle support, wherein:
the fiber bundle support is configured to house a plurality of optical fibers within an opening of the fiber bundle support; and
the laser beam modifies the first colored layer to form one or more laser-modified regions along an outer surface of the first colored layer.

13. The method of claim 12, further comprising translating the fiber bundle support along a fiber bundle support pathway while directing the laser beam onto the first colored layer of the fiber bundle support.

14. The method of claim 12, wherein:
the laser beam is output by a beam source of an optical system and directed to the first colored layer along a laser pathway, the optical system comprising a first cylindrical lens and a second cylindrical lens positioned along the laser pathway between the beam source and the first colored layer; and
the first cylindrical lens is rotated 90° about the laser pathway with respect to the second cylindrical lens.

15. The method of claim 12, wherein the laser beam is output by a beam source of an optical system along a laser pathway, the optical system comprising an aspheric optical element positioned along a first segment of the laser pathway between the beam source and a mirror, wherein:
the mirror optically couples the first segment of the laser pathway with a second segment of the laser pathway;
the first segment of the laser pathway is orthogonal with the second segment of the laser pathway;
the second segment of the laser pathway is collinear with a fiber bundle support pathway along which the fiber bundle support is positioned; and
the fiber bundle support pathway extends through a hole in the mirror.

16. The method of claim 12, wherein the laser beam is output by a beam source of an optical system along a laser pathway, the optical system comprising an off-axis parabolic mirror optically coupled to the beam source and optically coupling a first segment of the laser pathway with a second segment of the laser pathway, wherein:
the first segment of the laser pathway is orthogonal with the second segment of the laser pathway;
the second segment of the laser pathway is collinear with a fiber bundle support pathway along which the fiber bundle support is positioned; and
the fiber bundle support pathway extends through a hole in the off-axis parabolic mirror.

17. An optical fiber comprising:
a core;
a cladding surrounding the core; and
a first colored layer surrounding the cladding, wherein the first colored layer comprises an outer surface, the outer surface corresponding to an outermost surface of the optical fiber, the outer surface comprising a first portion with a first root-mean-square roughness and a second portion with a second root-mean-square roughness less than the first root-mean-square roughness.

18. The optical fiber of claim 17, further comprising a second colored layer disposed on and in direct contact with the first portion.

19. The optical fiber of claim 17, wherein the first portion of the outer surface and the second portion of the outer surface differ in optical reflectivity or scattering of visible light.

20. The optical fiber of claim 17, wherein the first root-mean-square roughness is in a range of from 50 nm to 500 nm.
